(19) United States
(12) Patent Application Publication
(10) Pub. No.: US 2018/0370741 A1
(43) Pub. Date: Dec. 27, 2018

(54) DEVICE FOR LOADING A HANDLING CONTAINER

(71) Applicant: Eric NETZHAMMER, Arlesheim (CH)

(72) Inventor: Eric NETZHAMMER, Arlesheim (CH)

(21) Appl. No.: 15/741,428

(22) PCT Filed: Jun. 30, 2016
(86) PCT No.: PCT/EP2016/065375

§ 371 Date: Jan. 2, 2018

(30) Foreign Application Priority Data
Jul. 3, 2015 (CH) 00968/15

(51) Int. Cl. B65G 65/23

(52) U.S. Cl. CPC B65G 65/23

(57) ABSTRACT

The device for loading a handling container via an alpha-beta port system has an alpha port, which is arranged in a movable manner in an axial direction and which can be lowered to the height necessary for docking to the beta port. For this purpose, the alpha port is arranged in an axially movable manner by means of a flexible membrane.

The invention relates to a device for the transfer of parts from a first containment to a second containment according to the pre-characterizing clause of claim 1, wherein the transferred parts only come into contact with the interior of the containment. As a rule, at least one containment is a clean room or a container in a clean room. The transfer is complete when the transferred goods are located in the second containment and this has been resealed with respect to the outside.

It is known from the prior art to use port systems, also known as “alpha-beta ports” or “Rapid Transfer Ports (RTP),” for transfers in clean rooms. With these systems, materials or sterilized parts can be transferred from one clean room to another clean room or from one containment to another.

The coupling of an alpha port to a beta port is mechanical. To enable the port system to be coupled together and the port doors to be opened, the alpha port and/or the beta port must first be moved such that they are located coaxially with respect to one another. In a second step, the alpha and/or beta port must then be moved approx. 30-40 mm axially against one another. Only in this position is a coupling and an opening of the port doors possible.

In a known system, with which stoppers or caps are introduced into a handling container by means of an alpha-beta port, the container equipped with a beta port is moved into the coaxial position below the alpha port. The subsequently required axial translatory movement is realized by raising the container. The conditions for coupling and opening are thereby fulfilled.

Although such a device is functionally suitable, the apparatus necessary for raising the handling container is accompanied by considerable mechanical, control and safety effort, especially as manual solutions can no longer be used due to the weight to be raised.

The invention is based on the object of avoiding these and further disadvantages.

According to the invention, this is achieved by the characterizing features of claim 1.

An exemplary embodiment of the invention is described below with reference to the attached drawings. In the drawings

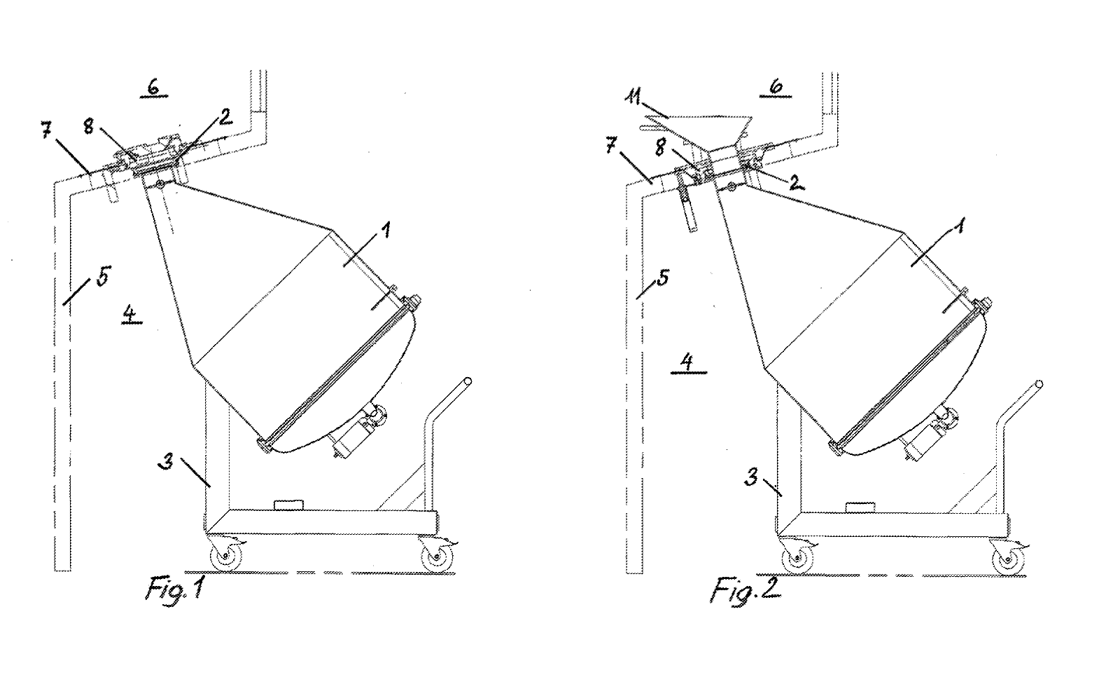

FIG. 1 shows a handling container in the position suitable for docking

FIG. 2 shows the docked handling container with open port

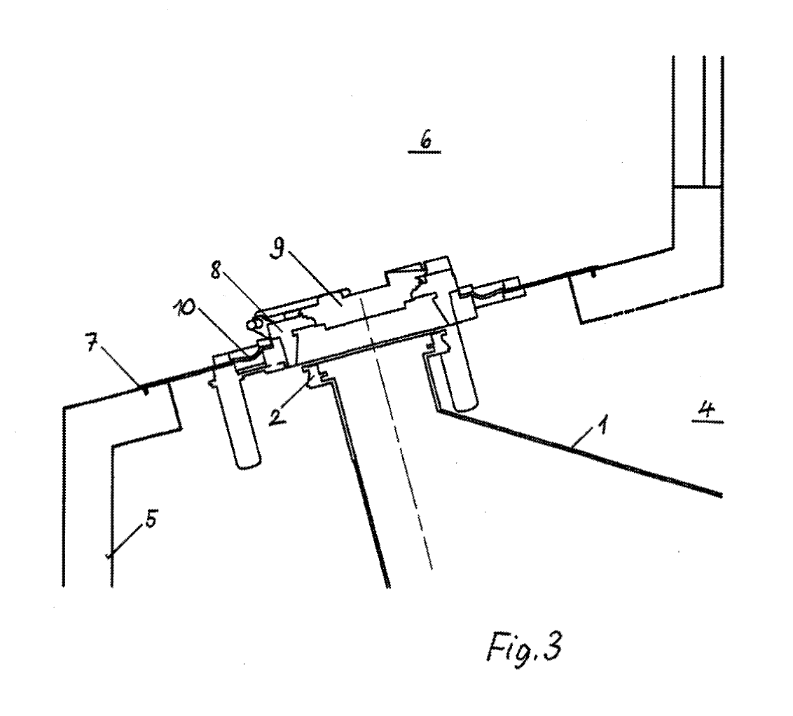

FIG. 3 shows a detailed sectional diagram of the port system before docking

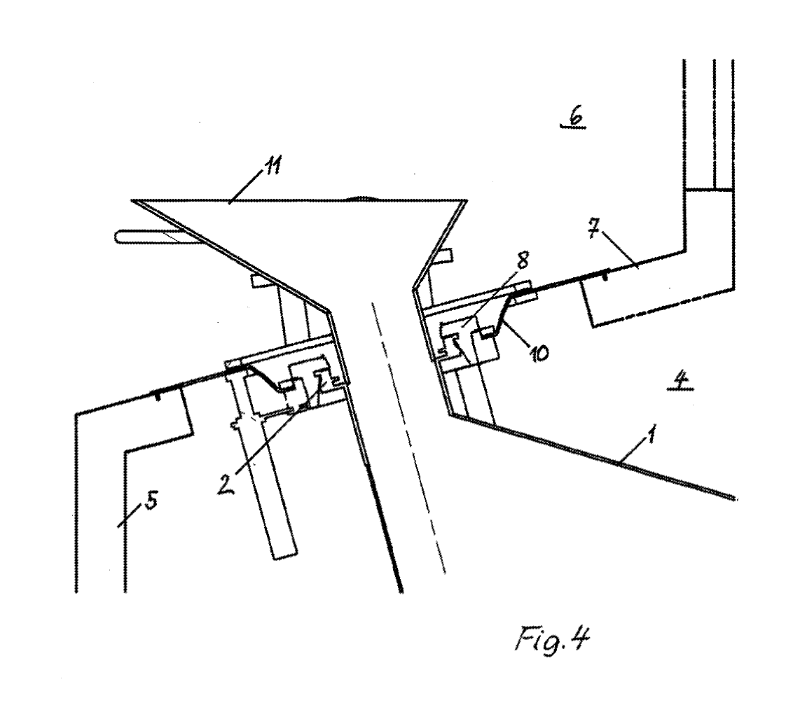

FIG. 4 shows a detailed sectional diagram of the port system in the docked state with open port.

A handling container 1 equipped with a beta port 2 is stationed as usual on a transport car 3 and is rotated into the loading position. The handling container is located in a clean room 4, for which it must be ensured that the parts to be handled do not come into contact with the atmosphere of the clean room. The clean room is separated by a wall 5 from a loading room 6, from which loading takes place. An alpha port 8, to which the beta port of the handling container can be docked, is arranged in a desk-shaped wall section 7. When the port cover 9 is opened after docking, the interior of the handling container is connected to the loading room 6. Contact with the clean room is precluded.

The alpha port located in the wall is arranged in an axially movable manner so that it can be lowered to the height relative to the beta port of the handling container necessary for docking. The movability of the port is achieved by a flexible membrane 10, by means of which the alpha port is fixed in the wall and which separates the loading room from the clean room at all times.

After docking, the port door can be opened and the parts to be handled can be loaded into the handling container. A funnel 11 can be attached for easier filling.

When transfer is complete, the port cover of the beta port on the container is reclosed, the two parts of the port are separated, and the retractable alpha port returns to its starting position.

1. A device for loading a handling container having parts to be handled, wherein the handling container is provided with a beta port, which, for loading, is docked to an alpha port, characterized in that the alpha port is arranged in a movable manner in an axial direction and can be lowered to the height necessary for docking to the beta port positioned coaxially with respect to the alpha port.

2. The loading device according to claim 1, characterized in that the alpha port is arranged in an axially movable manner by means of a flexible membrane.

3. The loading device according to claim 1, characterized in that the handling container is arranged in a clean room separated from a loading room by a wall.
